(19) United States
(12) Patent Application Publication
(10) Pub. No.: US 2026/0292853 A1
(43) Pub. Date: Sep. 24, 2026

(54) ASSISTANCE INFORMATION FOR SIDELINK POSITIONING

(71) Applicant: TELEFONAKTIEBOLAGET LM ERICSSON (PUBL), Stockholm (SE)

(72) Inventors: Min WANG, LULEÅ (SE); Ritesh SHREEVASTAV, UPPLANDS VÄSBY (SE); Xiaolin JIANG, LINKÖPING (SE); Muhammad Ali KAZMI, RESTON, VA (US); Ming LI, STOCKHOLM (SE)

(21) Appl. No.: 19/472,961

(22) PCT Filed: Apr. 5, 2024
(86) PCT No.: PCT/IB2024/053372

§ 371 Date: Oct. 6, 2025

Related U.S. Application Data
(60) Provisional application No. 63/457,524, filed on Apr. 6, 2023.

(51) Int. Cl. H04W 72/25; H04W 64/00; H04W 76/27

(52) U.S. Cl. CPC H04W 72/25; H04W 64/00; H04W 76/27

(57) ABSTRACT

Systems and methods for providing assistance information related to a sidelink connection are provided. A wireless device is configured to determine a condition associated with a sidelink connection between the wireless device and a second wireless device. The condition can be related to an instability of the sidelink connection. Assistance information is transmitted to a network node in accordance with determining the condition associated with the sidelink connection. One or more sidelink positioning measurements can be modified accordingly.

### CROSS REFERENCE TO RELATED APPLICATIONS

This application claims the benefit of U.S. Provisional Application No. 63/457,524 filed on Apr. 6, 2023, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz). Besides the typical mobile broadband use case, NR is being developed to also support machine type communication (MTC), ultra-low latency critical communications (URLCC), side-link device-to-device (D2D) and other use cases.

Positioning and location services have been topics in LTE standardization since 3GPP Release 9. An objective was to fulfill regulatory requirements for emergency call positioning but other use case like positioning for Industrial Internet of Things (I-IoT) are also considered. Positioning in NR is supported by the example architecture shown in FIG. 1. LMF 108A represents the location management function entity in NR. There are also interactions between the LMF 108A and the gNodeB 110 via the NRPPa protocol. The interactions between the gNodeB 110 and the device (UE) 112 are supported via the Radio Resource Control (RRC) protocol, while the location node 108A interfaces with the UE 112 via the LTE positioning protocol (LPP). LPP is common to both NR and LTE technologies. Other network nodes, such as Access and Mobility Management Function (AMF) 108B and evolved Serving Mobile Location Center (e-SMLC) 108C, may be involved in positioning support.

It will be appreciated that while FIG. 1 shows gNB 110B and ng-eNB 110A, both may not always be present. It is noted that when both the gNB 110B and ng-eNB 110A are present, the NG-C interface is generally only present for one of them.

NR positioning since Release 16, based on the 3GPP NR radio-technology, has provided added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE.

NR supports the following radio access technology (RAT)-dependent positioning methods.

DL-TDOA: The DL-TDOA positioning method makes use of the DL RSTD (and optionally DL PRS RSRP) of downlink signals received from multiple transmission points (TPs), at the UE. The UE measures the DL RSTD (and optionally DL PRS RSRP) of the received signals using assistance data received from the positioning server, and the resulting measurements are used along with other configuration information to locate the UE in relation to the neighbouring TPs.

Multi-RTT: The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

UL-TDOA: The UL-TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

DL-AoD: The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.

UL-AoA: The UL-AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

NR-ECID: NR Enhanced Cell ID (NR E-CID) positioning refers to techniques which use additional UE measurements and/or NR radio resource and other measurements to improve the UE location estimate.

The positioning modes can be categorized as UE-assisted, UE-based, or standalone.

UE-Assisted: The UE performs measurements with or without assistance from the network and sends these measurements to the E-SMLC where the position calculation may take place.

UE-Based: The UE performs measurements and calculates its own position with assistance from the network.

Standalone: The UE performs measurements and calculates its own without network assistance.

In the legacy LTE standards, the following techniques are supported:

Enhanced Cell ID: Essentially cell ID information to associate the device to the serving area of a serving cell, and then additional information to determine a finer granularity position.

Assisted GNSS: GNSS information retrieved by the device, supported by assistance information provided to the device from E-SMLC

OTDOA (Observed Time Difference of Arrival): The device estimates the time difference of reference signals from different base stations and sends to the E-SMLC for multilateration.

UTDOA (Uplink TDOA): The device is requested to transmit a specific waveform that is detected by multiple location measurement units (e.g. an eNB/gNB) at known positions. These measurements are forwarded to E-SMLC for multilateration

Sensor methods: Methods such as Biometric pressure sensor which provides vertical position of the device and Inertial Motion Unit (IMU) which provides displacement.

Previous standardization work on sidelink (SL) ranging and positioning has focused on the communication aspects. From a positioning perspective, in previous 3GPP releases, the network has been catering for the need of positioning for the cellular system. Exploiting SL measurements in device positioning is therefore a new paradigm for positioning using 3GPP technology.

3GPP specified the LTE D2D (device-to-device) technology, also known as ProSe (Proximity Services) in the Release 12 and 13 of LTE. Later in Rel. 14 and 15, LTE V2X related enhancements targeting the specific characteristics of vehicular communications were specified. 3GPP started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

The Sidelink transmissions over NR specified for Release 16 can be considered enhancements of the ProSe (PROximity-based SErvices) specified for LTE. Four new enhancements have been introduced to NR sidelink transmissions as follows:
Support for unicast and groupcast transmissions are added in NR sidelink. For unicast and groupcast, the Physical Sidelink Feedback Channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management are supported in NR sidelink transmissions.

To enable the above enhancements, new physical channels and reference signals are introduced in NR (available in LTE before):

PSSCH (Physical Sidelink Shared Channel, e.g. SL version of PDSCH): The PSSCH is transmitted by a sidelink transmitter UE, which conveys sidelink transmission data, system information blocks (SIBs) for radio resource control (RRC) configuration, and a part of the Sidelink Control Information (SCI).

PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.

PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.

Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.

Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.

DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another added feature is the two-stage Sidelink Control Information (SCI). This can be considered a version of the DCI for SL. Unlike the DCI, only part (e.g. the first stage) of the SCI is sent on the PSCCH. This part is used for channel sensing purposes (including the reserved time-frequency resources for transmissions, demodulation reference signal (DMRS) pattern and antenna port, etc.) and can be read by all UEs. The remaining part (e.g. the second stage) including scheduling and control information such as a 8-bits source identity (ID) and a 16-bits destination ID, NDI, RV and HARQ process ID is sent on the PSSCH to be decoded by the receiver UE.

Similar to PROSE in LTE, NR sidelink transmissions have the following two modes of resource allocations:

Mode 1: Sidelink resources are scheduled by a gNB.

Mode 2: The UE autonomously selects sidelink resources from a (pre-)configured sidelink resource pool(s) based on the channel sensing mechanism.

For an “in-coverage” UE, a gNB can be configured to adopt Mode 1 or Mode 2. For an “out-of-coverage” UE, only Mode 2 can be adopted.

As in LTE, scheduling over the sidelink in NR is done in different ways for Mode 1 and Mode 2.

### Mode 1 Supports the Following Two Kinds of Grants:

Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

### Mode 2 Resource Allocation

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

As described in clause 6.3.2.2 in 3GPP TR 37.985 v17.1.1, Mode 2 is for UE autonomous resource selection. Its basic structure is of a UE sensing, within a (pre-)configured resource pool, which resources are not in use by other UEs with higher-priority traffic, and choosing an appropriate amount of such resources for its own transmissions. Having selected such resources, the UE can transmit and re-transmit in them a certain number of times, or until a cause of resource reselection is triggered.

The Mode 2 sensing procedure can select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block, in a manner similar to the LTE-V2X scheme (clause 5.2.2.2). Finally, an initial transmission of a transport block can be performed after sensing and resource selection, but without a reservation.

The first-stage SCIs transmitted by UEs on PSCCH indicate the time-frequency resources in which the UE will transmit a PSSCH. These SCI transmissions are used by sensing UEs to maintain a record of which resources have been reserved by other UEs in the recent past. When a resource selection is triggered (e.g. by traffic arrival or a re-selection trigger), the UE considers a sensing window which starts a (pre-)configured time in the past and finishes shortly before the trigger time. The window can be either 1100 ms or 100 ms wide, with the intention that the 100 ms option is particularly useful for aperiodic traffic, and 1100 ms particularly for periodic traffic. A sensing UE also measures the SL-RSRP in the slots of the sensing window, which implies the level of interference which would be caused and experienced if the sensing UE were to transmit in them. In NR-V2X, SL-RSRP is a (pre-)configurable measurement of either PSSCH-RSRP or PSCCH-RSRP.

The sensing UE then selects resources for its (re-)transmission(s) from within a resource selection window. The window starts shortly after the trigger for (re-)selection of resources, and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

If the set of resources in the selection window which have not been excluded is less than a certain proportion of the available resources within the window, the SL-RSRP exclusion threshold is relaxed in 3 dB steps. The proportion is set by (pre-)configuration to 20%, 35%, or 50% for each traffic priority. The UE selects an appropriate amount of resources randomly from this non-excluded set. The resources selected are not in general periodic. Up to three resources can be indicated in each SCI transmission, which can each be independently located in time and frequency. When the indicated resources are for semi-persistent transmission of another transport block, the range of supported periodicities is expanded compared to LTE-V2X, in order to cover the broader set of envisioned use cases in NR-V2X.

Shortly before transmitting in a reserved resource, a sensing UE re-evaluates the set of resources from which it can select, to check whether its intended transmission is still suitable, taking account of late-arriving SCIs due, typically, to an aperiodic higher-priority service starting to transmit after the end of the original sensing window. If the reserved resources would not be part of the set for selection at this time (T3), then new resources are selected from the updated resource selection window. The cut-off time T3 is long enough before transmission to allow the UE to perform the calculations relating to resource re-selection.

FIG. 2 illustrates a summary of sensing and resource (re-)selection procedures as reproduced from FIG. 6.3.2.2-1 in 3GPP TR 37.985 V 17.1.1.

FIG. 3A illustrates an example timeline of the sensing and resource (re-)selection windows triggered at time n, without re-evaluation before (m-T3). Its first reserved resource is at time m, as per FIG. 6.3.2.2-2(a) in 3GPP TR 37.985 V 17.1.1.

FIG. 3B illustrates an example of the effect of the possibility of re-evaluation before first use of the reservation. FIG. 3B illustrates the timeline of sensing and resource (re-)selection procedure originally triggered at time n, which has a first reserved resource at time m, when re-evaluation occurring at m-T3 determines the resources are no longer selectable. The new re-evaluation cut-off becomes (m′-T3), as per FIG. 6.3.2.2-2(b) in 3GPP TR 37.985 V 17.1.1.

There are a number of triggers for resource re-selection, several of which are similar to LTE-V2X in Clause 5.2.2.2 in 3GPP TR 37.985 V 17.1.1. In addition, there is the possibility to configure a resource pool with a pre-emption function designed to help accommodate aperiodic sidelink traffic, so that a UE reselects all the resources it has already reserved in a particular slot if another nearby UE with higher priority indicates it will transmit in any of them, implying a high-priority aperiodic traffic arrival at the other UE, and the SL-RSRP is above the exclusion threshold. The application of pre-emption can apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

### SL Synchronization References and Priorities

As described in clause 6.2.2.1 of 3GPP TS 37.985 v 17.1.1, there are four basic sources, or references, from which a V2X UE can derive its own synchronization: GNSS, a gNB/eNB, another UE transmitting SLSS (here termed a SyncRef UE), or its own internal clock. In general, GNSS or eNB/gNB are regarded as the highest-quality sources. SyncRef UEs are distinguished between those which are directly synchronized to GNSS or a gNB/eNB, those which are 1 further step away, and those which are ≥2 further steps away from GNSS or gNB/eNB. As a last resort, a UE unable to find any other synchronization reference will use its own internal clock to transmit S-SSB. The V2X synchronization procedure defines a hierarchy or set of priorities among such synchronization references and requires all UEs to continuously search the hierarchy to get to the highest-quality one they can find. The general preference order is as follows:
Level 1: Either GNSS or eNB/gNB, according to (pre-)configuration.
Level 2: A SyncRef UE directly synchronized to a Level 1 source.
Level 3: A SyncRef UE synchronized to a Level 2 source, i.e. indirectly synchronized to a Level 1 source.
Level 4: Whichever of GNSS or eNB/gNB was not (pre-)configured as the Level 1 source.
Level 5: A SyncRef UE directly synchronized to a Level 4 source.
Level 6: A SyncRef UE synchronized to a Level 5 source, i.e. indirectly synchronized to a Level 4 source.
Level 7: Any other SyncRef UE.
Level 8: UE's internal clock.

The NR V2X scheme is intended to allow the merging of otherwise-separate hierarchies derived from GNSS and gNB/eNB, so that a UE is able to move between nearby such hierarchies without loss of sidelink service. However, since it is possible that a gNB/eNB does not itself have synchronization to GNSS, use of Levels 4-6 can be disabled when GNSS is used as Level 1, so that there is no deviation from the hierarchy being derived from GNSS.

As described in clause 6.2.2.2.1 of 3GPP TS 37.985 v 17.1.1, the Sidelink synchronization signal identity (SLSSID) itself conveys information about the synchronization source of the transmitting UE. In general, the further a UE is away from a high-quality source of GNSS or gNB/eNB, the lower quality will be its own synchronization and thus the quality of an SLSS it transmits. There are a series of association rules among SLSS IDs, designed to allow the identification, and propagation through the system of, high-quality synchronization sources. The operation of this procedure is essentially the same as LTE-V2X, described in Clause 5.1.2.2.1, with the main difference that there are 672 SLSS IDs in NR-V2X, divided into 0, 1, . . . , 335 for in-coverage indication and 336, . . . , 671 for out-of-coverage indication. The special SLSS IDs of 0, 336, and 337 in NR-V2X are used equivalently to 0, 168, and 169 respectively in LTE-V2X.

### SUMMARY

It is an object of the present disclosure to obviate or mitigate at least one disadvantage of the prior art.

There are provided systems and methods for providing assistance information related to sidelink positioning.

In a first aspect, there is provided a method performed by a first wireless device. The first wireless device comprises a radio interface and processing circuitry and is configured to determine a condition associated with a sidelink connection between the first wireless device and a second wireless device; and transmit, to a network node, assistance information in accordance with determining the condition associated with the sidelink connection.

In some embodiments, the condition is related to an instability of the sidelink connection associated with at least one positioning measurement.

In some embodiments, the condition can include one or more of: a change in velocity of at least one of the first wireless device and the second wireless device, a change in moving direction of at least one of the first wireless device and the second wireless device, a change in location of at least one of the first wireless device and the second wireless device, and a battery or transmit power of at least one of the first wireless device and the second wireless device.

In some embodiments, the condition can include one or more of: a cell change, a radio channel quality, a timing error, a sidelink synchronization source, a beam failure, and a radio resource control (RRC) state associated with at least one of the first wireless device and the second wireless device.

In some embodiments, the first wireless device further obtains configuration information associated with the sidelink connection including at least one criteria associated with triggering transmission of the assistance information. The configuration information can be received from the network node.

In some embodiments, the assistance information indicates that the sidelink connection between the first wireless device and the second wireless device is unstable.

In some embodiments, the assistance information can include one or more of: an identifier of at least one of the first wireless device and the second wireless device, an indication that a positioning measurement cannot be obtained, an indication of a cause for not obtaining the positioning measurement, and sidelink PRS resource information.

In some embodiments, the first wireless device further modifies a sidelink positioning measurement configuration. Modifying the sidelink positioning measurement configuration can be in accordance with determining the condition associated with the sidelink connection and/or in accordance with receiving a message indicating to modify the sidelink positioning measurement configuration.

In another aspect, there is provided a method performed by a network node. The network node comprises a radio interface and processing circuitry and is configured to receive, from a first wireless device, assistance information indicating a condition associated with a sidelink connection between the first wireless device and a second wireless device; and transmit, to at least one of the first wireless device and the second wireless device, a message indicating to modify a sidelink positioning measurement configuration.

In some embodiments, the network node further transmits, to the first wireless device, configuration information associated with the sidelink connection including at least one criteria associated with triggering transmission of the assistance information.

In some embodiments, modifying the sidelink positioning measurement configuration includes selecting at least one additional wireless device for sidelink positioning measurement. In some embodiments, the at least one additional wireless device can be selected in accordance with one or more of: mobility of the additional wireless device, stability of a sidelink connection associated with the additional wireless device; radio channel quality associated with the additional wireless device, and radio channel congestion associated with the additional wireless device.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of NR positioning architecture;

FIG. 2 illustrates a summary of the sensing and resource (re-)selection procedures;

FIG. 3A illustrates an example sensing and resource (re-)selection procedure without re-evaluation;

FIG. 3B illustrates an example sensing and resource (re-)selection procedure with re-evaluation;

FIG. 4 is an example communication system;

FIG. 5 illustrates examples of network coverage scenarios;

FIG. 6 illustrates examples of sidelink positioning and ranging;

FIG. 7 illustrates an example of a degraded sidelink connection;

FIG. 8 is a flow chart illustrating a method performed by a wireless device;

FIG. 9 is a flow chart illustrating a method performed by a network node;

FIG. 10 is a block diagram of an example wireless device;

FIG. 11 is a block diagram of an example network node;

FIG. 12 is a block diagram of an example host;

FIG. 13 is a block diagram illustrating an example virtualization environment; and

FIG. 14 is a communication diagram of a host communicating via a network node with a UE.

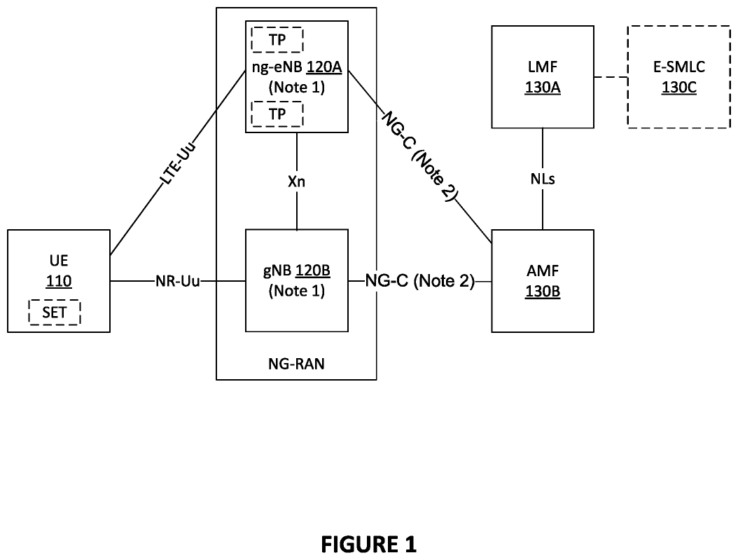

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

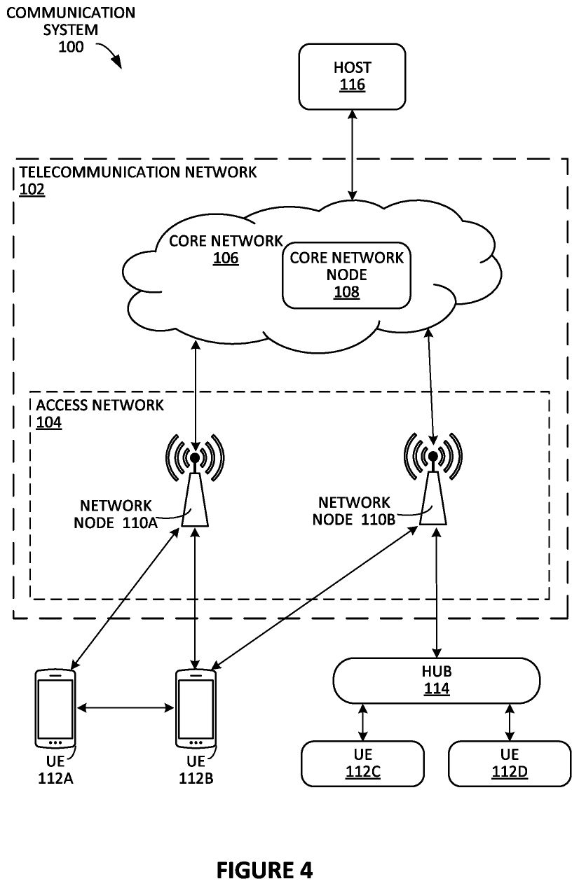

FIG. 4 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of positioning, in the current positioning support of LTE and NR systems, sidelink based ranging and positioning has been agreed to as a topic for Release 18 discussion. In a Rel-18 work item, it has been agreed to study positioning architecture and signaling procedures (e.g. configuration, measurement reporting, etc.) to enable sidelink positioning covering both UE based and network based positioning.

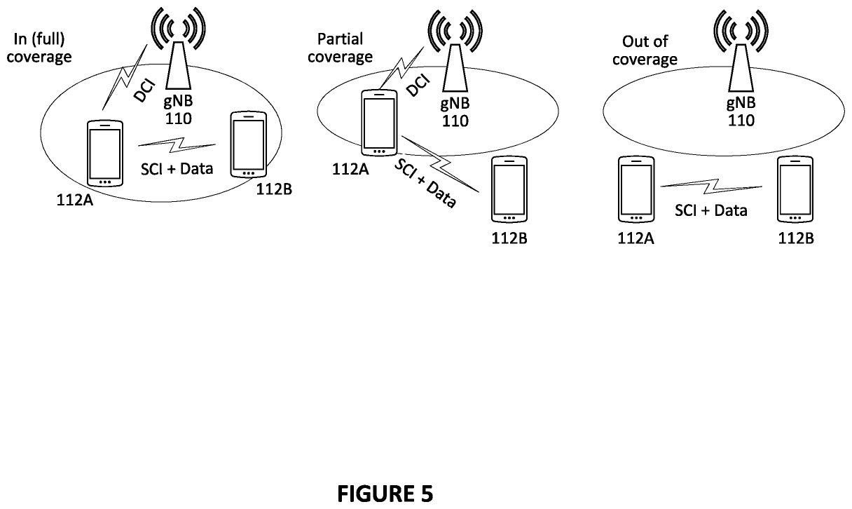

The studies are to be performed for the UE (i.e., the target UE which needs to be positioned) in various scenarios with different network coverage, including full coverage, partial coverage and out of coverage, as illustrated in FIG. 5.

FIG. 5 shows three exemplary network coverage scenarios for two UEs (112A, 112B) and a gNB (100) serving a cell. In the full coverage scenario (left), both UEs are in the coverage of the cell, such that they both can communicate with the gNB via respective Uu interfaces and directly with each other via the SL (e.g. PC5) interface. In the partial coverage scenario (center), only one of the UEs is in coverage of the cell, but the out-of-coverage UE can still communicate with the gNB indirectly via the SL interface with the in-coverage UE. In the out-of-coverage scenario, both UEs can only communicate with each other via the SL interface.

In general, the term “SL standalone” refers to direct communication between two SL-capable UEs (e.g. via PC5) in which source and destination are the UEs themselves. In contrast, the term “SL relay” refers to indirect communication between a network node and a remote UE via a first interface (e.g. Uu) between the network node an intermediate (or relay) UE and a second interface (e.g. PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured by the network (e.g. gNB) via RRC signaling and/or broadcast system information, either directly (via Uu interface) or indirectly (via PC5 interface and relay UE Uu interface). Out-of-coverage UEs rely on a (pre-)configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

In FIG. 5, the assisting UE 112A (which may also be referred to as the “reference UE”) can provide SL measurement assistance information to the target UE 112B.

For a target UE that is out-of-coverage, there may be different options for the target UE to be positioned. In one option, the target UE may choose to connect to the network via a SL U2N (UE to network) relay UE. In this case, the network can be involved in the positioning procedure for the target UE. In another option, the target UE may apply UE-based positioning by involving an assisting UE. If there is not any assisting UE found in the proximity, the target UE can reach an assisting UE in further range via a U2U (UE to UE) relay UE.

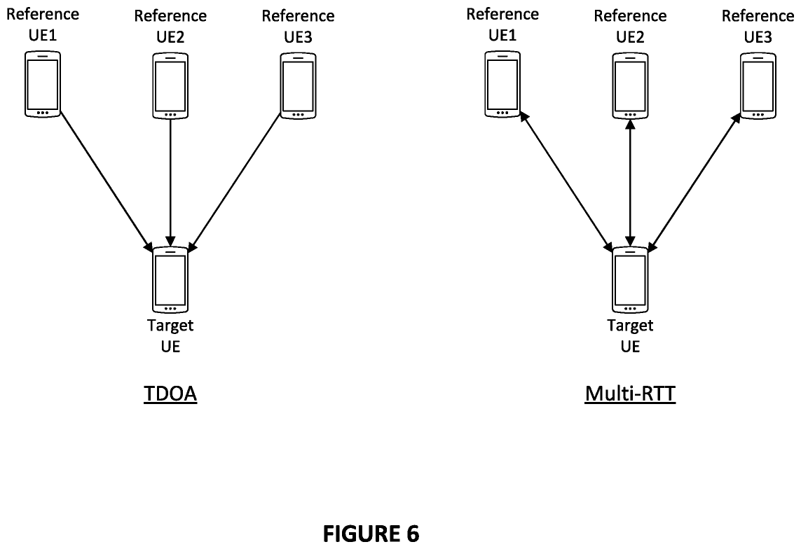

The same positioning methods including DL-TDOA, UL-TDOA, Multi-RTT, etc. are expected to be also applicable for SL-based positioning. For these methods, multiple assisting/reference UEs can be required, as shown in FIG. 6.

For SL-based positioning, certain methods such as TDOA may require tight synchronization among multiple assisting/reference UEs so that the transmissions of positioning reference signals from these reference UEs can arrive at the target UE in synchronized fashion. This can improve both positioning accuracy and avoid interference among reference UEs.

The role of the SL positioning server UE has been agreed to be defined for SL positioning in discussions in 3GPP RAN2 #120. For out-of-coverage scenario(s), the functionalities of method determination, assistant data distribution and/or anchor UE selection can be performed by the SL positioning server UE.

The functions of the SL positioning server UE are further discussed in 3GPP RAN2 #121. For cases without LMF involvement, besides method determination, assistant data distribution and anchor UE selection (agreed in RAN2), the SL positioning server UE may perform SL-PRS configuration coordination and location calculation.

The existing NR positioning mechanisms are expected to be reused for SL positioning as much as possible. In the existing positioning procedure (e.g. multi-RTT based positioning), the UE and the gNB need to provide measurements (e.g. RTT measurements) to the LMF, before a response time elapsed (i.e. the LMF may indicate the time period in the assistance information which is provided to the UE and the gNB by the LMF). If the UE or the gNB is unable to perform the requested measurements, or the Response Time elapsed before any of the requested measurements were obtained, the UE or the gNB returns any information that can be provided which includes a cause indication for the not provided location information.

For SL positioning, depending on the network coverage status of a target UE (i.e., in coverage or out of coverage), a positioning procedure/positioning session may involve the target UE, one or multiple reference UEs (also referred to as anchor UEs), one positioning server UE, or an LMF. A SL connection between any two UEs may be affected by many factors including mobility of the UEs, propagation characteristics, timing errors, etc. Due to changing of any one of these factors, the SL connection may become unstable. In this case, the UEs of the affected SL connection may be unable to provide the measurement results to the LMF or the positioning server UE, which may lead to a ranging/positioning failure.

Accordingly, some embodiments described herein involve assistance information reporting being defined for a reference UE, and/or a target UE, to reflect that the SL link between the reference UE and the target UE is unstable. The reporting can also indicate that the positioning measurements cannot be completed in the required time due to an unstable SL link. The reference UE or the target UE can send the assistance information reporting to the LMF or the positioning server UE. Upon reception of the report, the LMF or the positioning server UE can take proper actions to assist the further positioning measurements for the target UE.

### Some Embodiments Include

Defining failure events or conditions based on which an assistance information reporting will be triggered to indicate the unstable SL connection between the concerned reference UE and the concerned target UE.
Defining signaling details for the assistance information reporting which indicate the unstable SL connection between the concerned reference UE and the concerned target UE.
Defining actions for the concerned reference UE in case the unstable SL connection is detected.
Defining actions for the concerned target UE in case the unstable SL connection is detected.
Defining actions for the LMF or the positioning server UE in case the unstable SL connection is detected.

The various embodiments will be described in the context of NR, i.e., target UE and reference/assisting UE are deployed in a same or different NR cells. The link between a target UE and an assisting UE may be based on LTE sidelink, NR sidelink, or any other short-range communication technology such as Wifi. The Uu connection between the target UE or the reference UE and a base station may be LTE Uu or NR Uu.

The terms location server, positioning server, LMF, E-SMLC can be used inter-changeably, at least in some examples.

The term “time resource” used herein may correspond to any type of physical resource or radio resource expressed in terms of length of time. Examples of time resources are: symbol, time slot, subframe, radio frame, TTI, interleaving time, slot, sub-slot, mini-slot, etc.

In the embodiments, various conditions/events are defined for a SL connection between two SL UEs to reflect the stability status of the SL connection. When one of the conditions/events is met, the UEs can transmit a signaling to the LMF or the positioning server indicating that the SL connection is not stable for the moment so that the required SL positioning measurements cannot be completed within the required time period. The SL connection may be in any SL cast type, including unicast, groupcast or broadcast. In the case of SL unicast, the connection corresponds to a unicast connection between the two UEs. In the case of SL groupcast or SL broadcast, the two UEs are not required to establish a unicast link. The two UEs can exchange data/information via SL transmissions addressed to a groupcast/broadcast specific Destination L2 ID, i.e., a L2 ID assigned/provisioned to SL groupcast or broadcast for SL positioning.

Depending on the network coverage status of a target UE (e.g. in coverage or out of coverage), a positioning procedure/positioning session may involve the target UE, one or multiple reference UEs (also referred to as anchor UEs), one positioning server UE, or an LMF.

### Reference UE

In some embodiments, a reference UE can send an assistance/report message to a location server (e.g. LMF) or a positioning server UE indicating that the SL connection between the reference UE and the target UE is unstable/in poor condition or experiencing a radio link problem so that the required positioning measurements cannot be obtained in time when one or more of the following conditions or criteria are met. The conditions can be pre-defined or configured by a network node (e.g., LMF or positioning sever UE). Examples of the condition(s) can include one or more of the following:
The reference UE's velocity has changed over a configured threshold (e.g. X1 meters/second) since the last reported message or the last measurement performed by the reference UE. The parameter X1 can be autonomously determined by the reference UE, pre-defined or configured by a network node (e.g. LMF or positioning sever UE). For example, the velocity is increased so that the SL connection quality becomes worse/unstable.
The reference UE's moving direction has changed over a configured angle (e.g. X2 degree) since the last reported message or the last measurement performed by the reference UE. The parameter X2 can be autonomously determined by the reference UE, pre-defined or configured by a network node (e.g., LMF or positioning sever UE). For example, due to a change in the UE's moving direction, the SL connection quality becomes worse/unstable.
The reference UE's location has changed by more than certain threshold (e.g. by more than X3 distance units, e.g. by more than X3 meters) since a reference time. The reference UE's location can be expressed in terms of geographical co-ordinates. In one example, the reference time (Tr) is the time when the reference UE was configured to assist the target UE to perform the SL positioning measurement on the SL connection. In another example, Tr is the time when the reference UE has sent the last reported message or the last measurement performed by the reference UE. The reference UE may be configured to assist the target UE to perform the SL positioning measurement on the SL connection provided that the reference UE's location does not change by more than the certain threshold since the Tr. The parameter X3 can be autonomously determined by the reference UE, pre-defined or configured by a network node (e.g. LMF or positioning sever UE).
The reference UE has moved outside a reference zone or region or geographical area (Rz). The parameter Rz can be 1-dimensional, 2-dimensional or 3-dimensional zone, which can be defined by a set of two or more geographical co-ordinates. The reference UE may be configured to assist the target UE to perform the SL positioning measurement on the SL connection provided that the reference UE is located within Rz. The parameter Rz or a set of coordinates defining Rz can be autonomously determined by the reference UE, pre-defined or configured by a network node (e.g. LMF or positioning sever UE).
The reference UE's measured radio channel quality in terms of one or more of RSRP, RSRQ, RSSI, SINR, SIR, etc. has changed over a configured threshold (e.g. X4 dB in case of RSRP measurement) since the last report message or the last measurement. For example, the radio channel quality is decreased over the threshold so that the SL connection quality becomes worse/unstable.
The reference UE's measured congestion status in terms of channel busy ratio (CBR) or channel usage ratio (CR), etc. has changed over a configured threshold since the last report message or the last measurement. For example, the radio channel becomes more congested so that a SL positioning transmission may experience interference so that the SL positioning measurements cannot meet the positioning accuracy.
The reference UE has experienced/been experiencing timing errors (e.g., the measured timing error is over a configured threshold).
The reference UE has changed/been changing to a different SL synchronization source, which is lower priority than the previous synchronization source.
The reference UE has experienced/been experiencing a cell change (i.e. cell change such as handover to a different serving cell). Examples of cell change are handover, PSCell change in dual connectivity, secondary cell (SCell) change, RRC release with re-directon, RRC connection re-establishment etc.
The reference UE has detected a beam failure on a SL between the reference UE and the target UE.
The RRC state of the reference UE has changed. In one example the RRC state of the reference state has changed from high activity RRC state (e.g. RRC connected state) to a low activity RRC state (e.g. RRC idle, RRC inactive, etc).
The battery power of the reference UE has fallen below certain threshold e.g., below 20% of the maximum UE's battery power.
The maximum transmit power (Pmax) of the reference UE has been reduced below certain threshold. In one example, the Pmax is reduced below certain threshold by the reference UE autonomously. In another example, the Pmax is reduced below certain threshold based on a message received from the network node. The Pmax may be reduced below the threshold to meet one or more performance requirements and/or regulatory requirements related to radio emissions. For example, the UE may reduce the Pmax by applying one or more of power offset value (B). Example of β is maximum power reduction (MPR), an additional (MPR), a power management MPR (P-MPR) etc. For example, Pmax,2=(Pmax,1-B); where Pmax,2 is the current Pmax after applying the power offset and Pmax, 1 was the Pmax before applying the power offset. Examples of such regulatory requirements are additional out of band emission, additional spurious, maximum allowed radiation and heat exposure to human to comply with the human exposure requirements (e.g., specific absorption rate (SAR) level) etc.
The reference UE is performing a beam failure recovery (BFR) procedure on the SL connection with respect to the target UE. The reference UE may start performing BFR procedure upon beam failure detection on the SL connection with respect to the target UE.
The reference UE is performing a candidate beam detection on the SL connection with respect to the target UE.
The reference UE has experienced/been experiencing the SL RLF in the SL connection. In one example, this may be detected upon indication from sidelink RLC entity that the maximum number of retransmissions for the SL connection has been reached. In another example, this may be detected upon indication from MAC entity that the maximum number of consecutive HARQ DTX for the SL connection has been reached. In another example, this may be detected upon integrity check failure indication from sidelink PDCP entity concerning a SL SRB for the SL connection. In another example, this may be detected upon a timer expiry indicating that the reference UE has sent a RRC signaling to the target UE, while no response received from the target UE before the timer expired.
The reference UE has detected in-device coexistence (IDC) problem. For example, the reference UE may transmit an indicator to the position server indicating that the UE has detected an IDC problem and therefore it cannot assist the target UE for the SL positioning. The reference UE may also indicate the time period or expected time period during which or a reference time (e.g. UTC time) until when the IDC problem is expected to persist. The interference generated by the signal transmission on one or more external wireless system (EWS) on the same device (i.e. on the reference UE) can cause the IDC problem on the cellular carrier frequency (e.g. LTE, NR carriers) used for SL operation wrt the target UE. The IDC problem is particularly severe when the cellular carriers are adjacent or close in frequency domain to those used for EWS operation. Examples of the EWS are WiFi, Bluetooth, GNSS (e.g., GPS, Galileo, etc.), etc. For example, the interference from the EWS may be generated in terms of harmonics, intermodulation product, etc., to the cellular receiver on the SL carrier used for the SL positioning measurement.

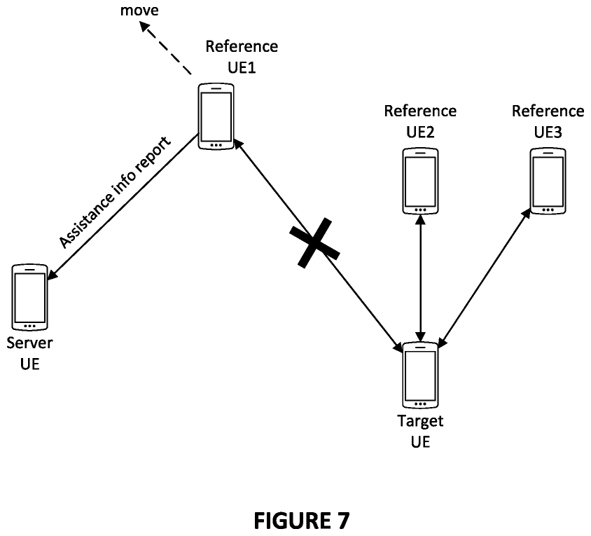

FIG. 7 illustrates an example of the assistance information report mechanism. In this example, reference UE1 moves away from the target UE, which causes the SL connection between the reference UE1 and the target UE to become unstable. When the measured channel quality drops below a configured threshold, reference UE1 transmits a message to the positioning server UE (or alternatively, to the location server) indicating that its connection with the target UE has degraded so that the required positioning measurements cannot be obtained by UE1.

In some embodiments, the assistance message may comprise at least one of the following information:
An identifier/identity (ID) of the UE which has sent the message
   E.g., an Uu ID may be a RNTI, TMSI, IMSI, Resume ID, etc.
   E.g., an SL L2 ID
   E.g., a local ID or a temp ID which is determined based on an Uu ID or an SL L2 ID of the UE
An ID of the target UE
   Together with the ID of the reference UE/the reporting UE, the concerned SL connection can be identified.
   Alternatively, an ID of the concerned SL connection may be included in the message
An indicator indicating that the required measurements cannot be obtained in the required time period.
   In case the UE is asked to perform multiple measurements, the UE may include the information on the measurement occasions (e.g., the PRS resources and the time instant that the measurement is required to be performed) which cannot be completed
The measurement results that the UE has completed up to now
   In case the UE is asked to perform multiple measurements, the UE may include each measurement result and the associated time stamp
A cause value indicating the reason why the required measurements cannot be obtained in the required time period
One or multiple candidate SL PRS resources which is preferred by the reference UE for further measurements
Preferred SL PRS configuration. This may comprise one or more parameters defining the SL PRS resource configuration e.g., PRS resource periodicity, PRS BW etc.
One or multiple candidate reference UEs if this reference UE is not suitable anymore for further measurements

As an additional embodiment, the reference UE may suspend the SL positioning measurements on the concerned SL connection when an assistance message is sent to the LMF or the positioning server UE indicating that the required SL positioning measurements cannot be obtained.

### Target UE

In some embodiments, a target UE may send an assistance/report message to the LMF or a positioning server UE, indicating that the SL connection between a reference UE and the target UE is unstable/in bad condition so that the required positioning measurements cannot be obtained in time.

The assistance message may be triggered according to one or more conditions or criteria as described in the above embodiments for a reference UE.

The assistance message comprises same content as an assistance message sent by a reference UE as described herein.

LMF and/or Positioning Server UE

In some embodiments, upon reception of an assistance message from a reference UE indicating that the required SL positioning measurements cannot be obtained in the required time period due to the SL connection is unstable/bad condition, the location server (e.g. LMF) or the positioning server UE may perform at least one of the below actions for the reported events:
Send a message to the reference UE indicating abort of the required ranging/positioning measurement
Send a message to the reference UE indicating update to the ranging/positioning measurement/configuration
Send a message to the reference UE indicating that the reference UE is not selected any more in the ranging/positioning procedure/measurement for the target UE
Send a message to the target UE indicating that the concerned reference UE is not selected any more in the ranging/positioning procedure/measurement for the target UE
Send a message to the target UE indicating one or multiple other reference UEs to be involved/assisting in the positioning procedure/further ranging/positioning measurements
Selecting one or more new reference UEs for assisting the target UE to perform SL positioning measurement. The location server (e.g., LMF) or the positioning server UE may further inform the target UE information about the selected one or more new reference UEs for performing the SL positioning measurement.

In some embodiments, upon reception of an assistance message from a target UE indicating that the required SL positioning measurements cannot be obtained in the required time period due to the SL connection is unstable/bad condition, the LMF or the positioning server UE may perform at least one of the below actions for the reported events:
Send a message to the target UE indicating abort of the required ranging/positioning measurement
Send a message to the target UE indicating update to the ranging/positioning measurement/configuration
Send a message to the target UE indicating that the concerned reference UE is not selected any more in the positioning procedure/measurement for the target UE
Send a message to the target UE indicating one or multiple other reference UEs to be involved/assisting in the positioning procedure/further ranging/positioning measurements

In some embodiments, considering the assistance information from the target UE and/or reference UEs, the LMF and/or the server UE can determine to select or reselect a reference UE considering the below conditions:
Select a reference UE with less mobility
Select a reference UE which has more stable connection to the target UE
Select a reference UE with stronger radio channel quality to the target UE
Select a reference UE with less congested radio channel to the target UE

### Signaling

For any of the above embodiments, any signaling exchanged between two UEs (between a target UE and a reference UE, between a target UE and a server UE or between a reference UE and a server UE) may comprise one or more of the following signaling alternatives:
A SL positioning signaling (e.g., in SL positioning protocol)
A SL discovery procedure
A PC5-S signaling
A PC5-RRC signaling
A MAC CE based signaling
A L1 signaling (e.g., a signaling carried by PSSCH channel, e.g., a SCI, or carried by PSFCH channel)

The signaling exchange between any UE (reference UE or target UE) and LMF, can include:
A new LPP or SLPP message
Modification of LPP or SLPP Assistance data exchange message.

In one example, a new failure cause information element can be defined to reflect the unstable link/anchor UE.

```
SidelinkMeasurementFailureCause ::= ENUMERATED {
  undefined,
  unreliableSynchSource,
  noSynchSource,
  noAnchorUE,
  anchorUE-Moved,
  coverageChange,
  errorEncountered,
  ...
}
```

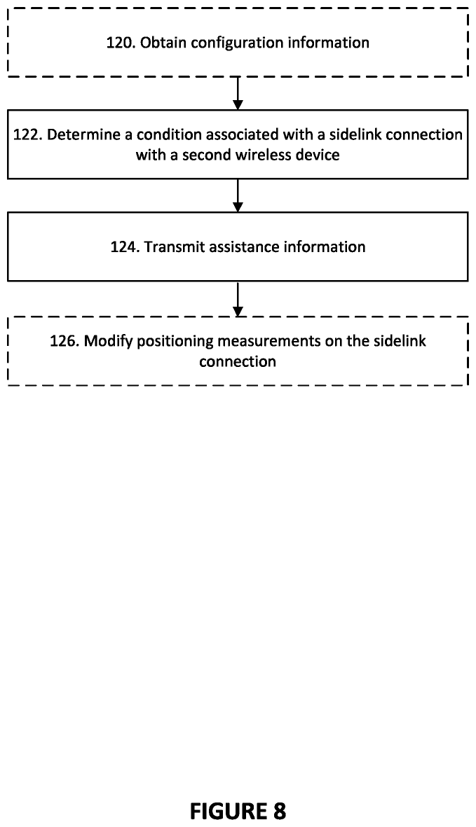

FIG. 8 is a flow chart illustrating an example method performed by a wireless device, such as a UE 112 as described herein. The wireless device can be a reference UE or a target UE as described herein. The wireless device can have a sidelink connection with one or more other wireless devices. The method can include:

Step 120: Optionally, the wireless device obtains configuration information associated with a sidelink connection. The configuration information can include one or more parameters, thresholds and/or criteria associated with triggering the transmission of assistance information related to sidelink positioning. The configuration information can be received from a network node (e.g. LMF) and/or from another wireless device, such as a positioning server device.

Step 122: The wireless device determines a condition associated with a sidelink connection with a second wireless device. In some embodiments, the condition can be related to a change in the sidelink connection between the two devices that may cause a positioning measurement to not be completed and/or delayed. In some embodiments, the condition is related to an instability of the sidelink connection.

In some embodiments, the condition associated with the sidelink connection can include one or more of:
a change in velocity of the wireless device and/or the second wireless device;
a change in moving direction of the wireless device and/or the second wireless device;
a change in location of the wireless device and/or the second wireless device;
a change in radio channel quality associated with the wireless device and/or the second wireless device;
a timing error associated with the wireless device and/or the second wireless device;
a change in the SL synchronization source associated with the wireless device and/or the second wireless device;
a cell change associated with the wireless device and/or the second wireless device;
a beam failure associated with the wireless device and/or the second wireless device;
an RRC change associated with the wireless device and/or the second wireless device;
battery power of the wireless device and/or the second wireless device; and/or
transmit power of the wireless device and/or the second wireless device.

Each of the conditions can be associated with a respective threshold and/or criteria that can be detected by the wireless device. The respective thresholds/criteria can be pre-configured or obtained via the received configuration information.

Step 124: The wireless device transmits an assistance information message in response to, or in accordance with, determining the condition associated with the sidelink connection. The assistance information message can be transmitted to a network node such as a location server and/or a positioning server device. In some embodiments, the assistance information can indicate that the sidelink connection is unstable.

In some embodiments, the assistance information message can include one or more of:
an identifier of the wireless device and/or the second wireless device;
an indication that at least one positioning measurement cannot be obtained;
an indication of the cause for not obtaining the at least one positioning measurement;
measurement results;
sidelink PRS resource information; and/or
reference UE information.

Step 126: Optionally, the wireless device can modify, cancel or suspend sidelink positioning measurements associated with the sidelink connection with the second wireless device. In some embodiments, modifying the sidelink positioning measurement can be in accordance with determining the condition associated with the sidelink connection. In some embodiments, modifying the sidelink positioning measurement can be in accordance with receiving a message (e.g. from the network node) indicating to modify the sidelink positioning measurement configuration.

It will be appreciated that one or more of the above steps can be performed simultaneously and/or in a different order. Also, steps illustrated in dashed lines are optional and can be omitted in some embodiments.

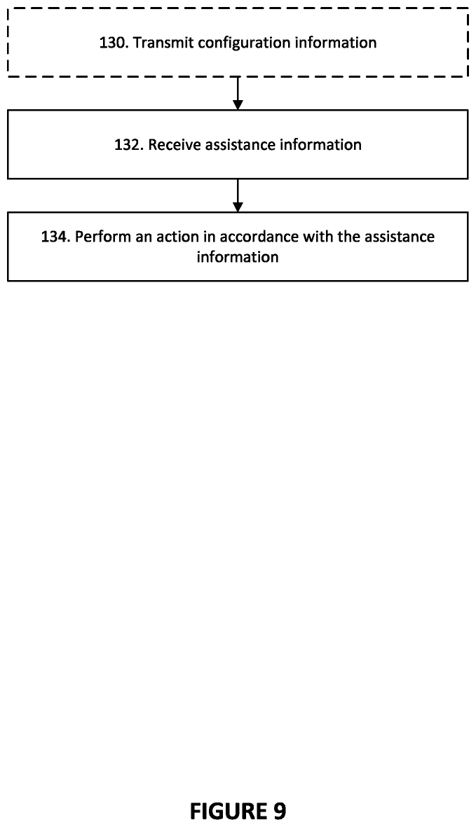

FIG. 9 is a flow chart illustrating an example method performed by a network node. The network node can be a core network node 108 (e.g. location server, LMF) or a positioning server device as described herein. The positioning server device can be a wireless device, such as a UE 112 as described herein. The method can include:

Step 130: Optionally, the network node transmits configuration information associated with a sidelink connection. In some embodiments, the configuration information can include one or more parameters, thresholds and/or criteria associated with triggering the transmission of assistance information related to sidelink positioning. The configuration information can be transmitted to one or more wireless devices.

Step 132: The network node receives an assistance information message. The assistance information message can be received from a wireless device. The assistance information message can indicate that a positioning measurement cannot be obtained and/or indicate a condition of a sidelink connection. The sidelink connection can be associated with the wireless device and one or more second wireless devices.

In some embodiments, the assistance information message can include one or more of:
an identifier of the wireless device and/or the second wireless device;
an indication that at least one positioning measurement cannot be obtained;
an indication of the cause for not obtaining the at least one positioning measurement;
measurement results;
sidelink PRS resource information; and/or
reference UE information.

Step 134: The network node performs one or more actions in response to, or in accordance with, the received assistance information.

In some embodiments, the action can include transmitting a message to update, modify, suspend and/or abort a positioning/ranging measurement procedure. The message can be transmitted to a wireless device, such as the reference UE or the target UE as described herein.

In some embodiments, the action can include selecting one or more additional wireless devices for sidelink positioning measurement. The selection (or re-selection) can be based on one or more of:
mobility of the additional wireless device;
stability of a sidelink connection associated with the additional wireless device;
radio channel quality associated with the additional wireless device; and/or
radio channel congestion associated with the additional wireless device.

The network node can transmit a message indicating the identity of the selected additional wireless device for positioning to the selected device itself or, alternatively, to another wireless device such as a reference UE or target UE as described herein.

It will be appreciated that one or more of the above steps can be performed simultaneously and/or in a different order. Also, steps illustrated in dashed lines are optional and can be omitted in some embodiments.

It will be appreciated that in some embodiments, a wireless device 112 can communicate (e.g. transmit/receive messages) directly with a network node such as location server 108. In other embodiments, messages and signals between the entities may be communicated via other nodes, such as radio access node (e.g. gNB, eNB) 110.

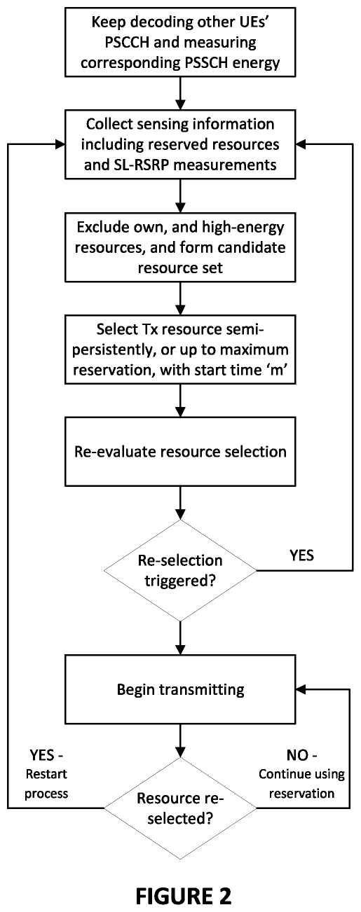

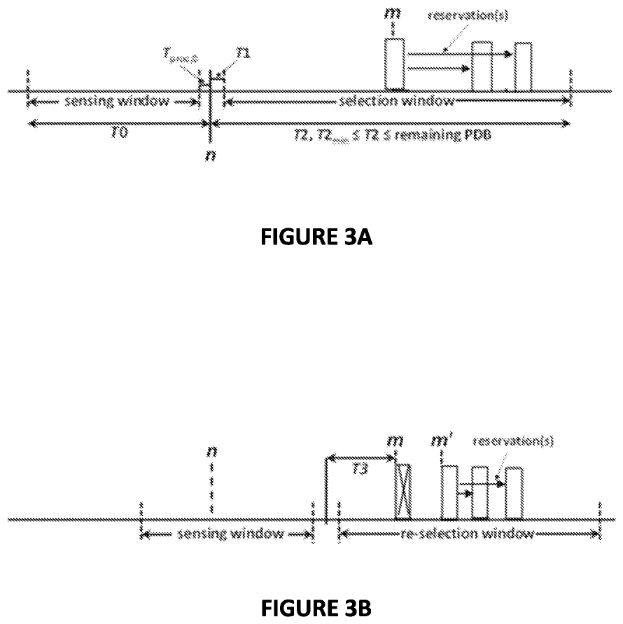

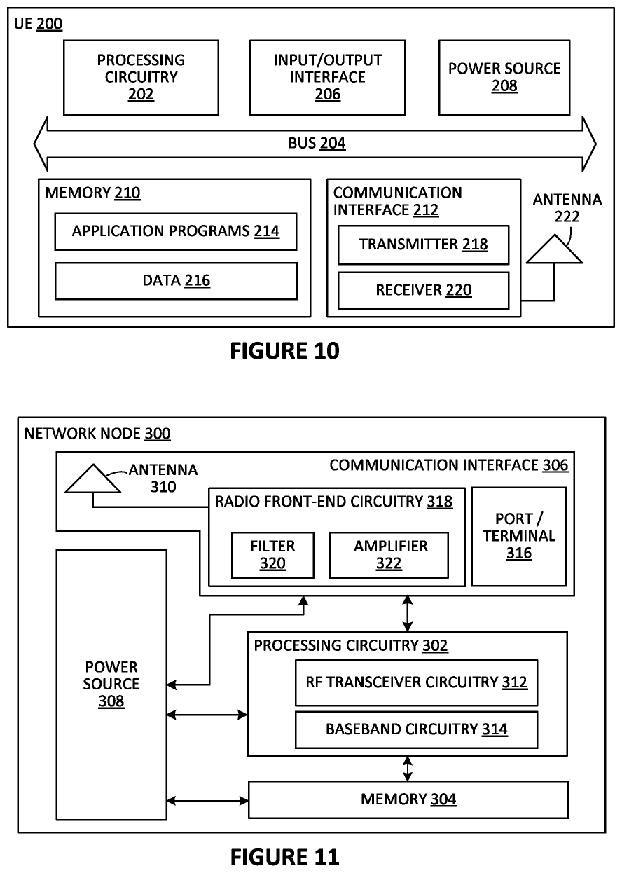

FIG. 10 shows a UE 200, which may be an embodiment of the UE 112 of FIG. 2 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 300, which may be an embodiment of the access node 110 or the core network node 108 of FIG. 2, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

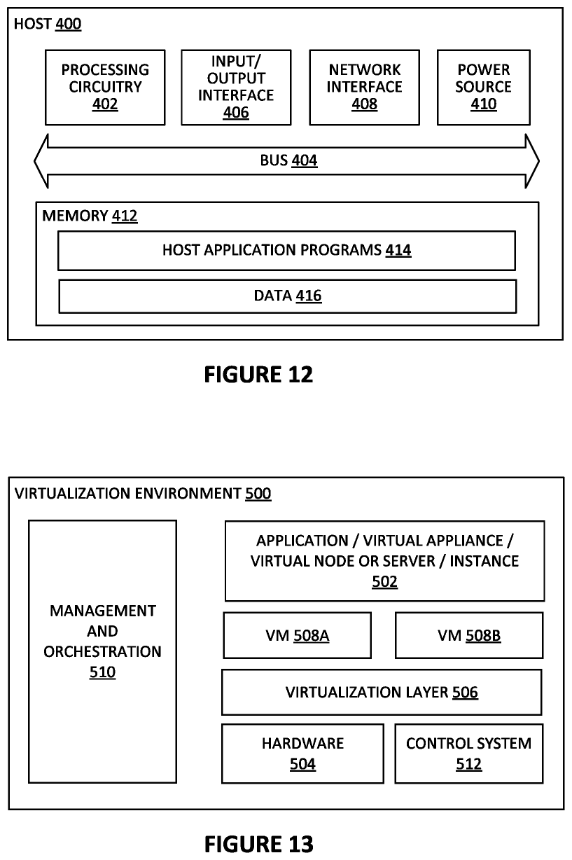

FIG. 12 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 10 and 11, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

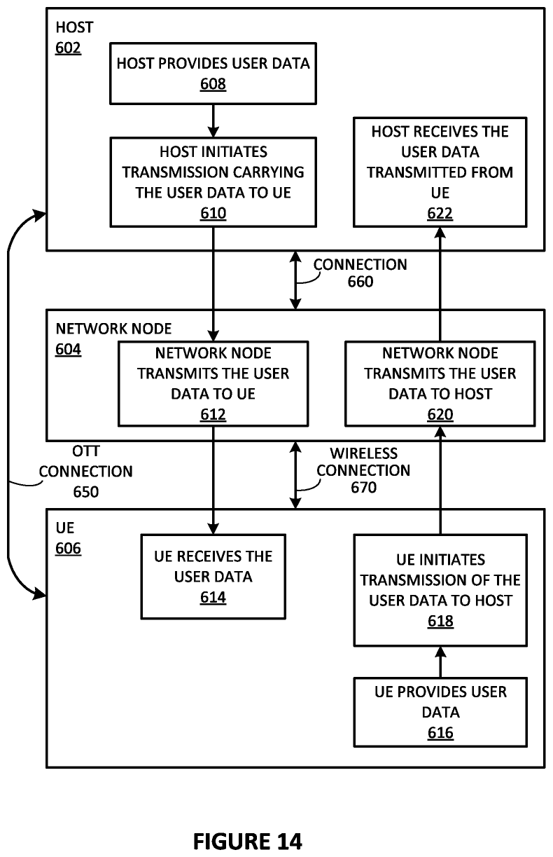

FIG. 14 shows a communication diagram of a host 602 communicating via a network node 604 with a UE 606 over a partially wireless connection in accordance with some embodiments. Example implementations, in accordance with various embodiments, of the UE (such as a UE 112A of FIG. 2 and/or UE 200 of FIG. 10), network node (such as network node 110A of FIG. 2 and/or network node 300 of FIG. 11), and host (such as host 116 of FIG. 2 and/or host 400 of FIG. 12) discussed in the preceding paragraphs will now be described with reference to FIG. 14.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
   Reference Signal Received Power
RSRQ Reference Signal Received Quality OR
   Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a first wireless device, the method comprising:
determining a condition associated with a sidelink connection between the first wireless device and a second wireless device; and
transmitting, to a network node, assistance information in accordance with determining the condition associated with the sidelink connection.

2. The method of claim 1, wherein the condition is related to an instability of the sidelink connection associated with at least one positioning measurement.

3. The method of any one of claims 1 to 2, wherein the condition includes one or more of: a change in velocity of at least one of the first wireless device and the second wireless device, a change in moving direction of at least one of the first wireless device and the second wireless device, a change in location of at least one of the first wireless device and the second wireless device, and a battery or transmit power of at least one of the first wireless device and the second wireless device.

4. The method of any one of claims 1 to 3, wherein the condition includes one or more of: a cell change, a radio channel quality, a timing error, a sidelink synchronization source, a beam failure, and a radio resource control (RRC) state associated with at least one of the first wireless device and the second wireless device.

5. The method of any one of claims 1 to 4, further comprising, obtaining configuration information associated with the sidelink connection including at least one criteria associated with triggering transmission of the assistance information.

6. The method of claim 5, wherein the configuration information is received from the network node.

7. The method of any one of claims 1 to 6, wherein the assistance information indicates that the sidelink connection between the first wireless device and the second wireless device is unstable.

8. The method of any one of claims 1 to 7, wherein the assistance information includes one or more of: an identifier of at least one of the first wireless device and the second wireless device, an indication that a positioning measurement cannot be obtained, an indication of a cause for not obtaining the positioning measurement, and sidelink PRS resource information.

9. The method of any one of claims 1 to 8, further comprising, modifying a sidelink positioning measurement configuration.

10. The method of claim 9, wherein modifying the sidelink positioning measurement configuration is in accordance with determining the condition associated with the sidelink connection.

11. The method of claim 9, wherein modifying the sidelink positioning measurement configuration is in accordance with receiving a message indicating to modify the sidelink positioning measurement configuration.

12. A first wireless device comprising a radio interface and processing circuitry configured to:
determine a condition associated with a sidelink connection between the first wireless device and a second wireless device; and
transmit, to a network node, assistance information in accordance with determining the condition associated with the sidelink connection.

13. The first wireless device of claim 12, wherein the condition is related to an instability of the sidelink connection associated with at least one positioning measurement.

14. The first wireless device of any one of claims 12 to 13, wherein the condition includes one or more of: a change in velocity of at least one of the first wireless device and the second wireless device, a change in moving direction of at least one of the first wireless device and the second wireless device, a change in location of at least one of the first wireless device and the second wireless device, and a battery or transmit power of at least one of the first wireless device and the second wireless device.

15. The first wireless device of any one of claims 12 to 14, wherein the condition includes one or more of: a cell change, a radio channel quality, a timing error, a sidelink synchronization source, a beam failure, and a radio resource control (RRC) state associated with at least one of the first wireless device and the second wireless device.

16. The first wireless device of any one of claims 12 to 15, further configured to obtain configuration information associated with the sidelink connection including at least one criteria associated with triggering transmission of the assistance information.

17. The first wireless device of claim 16, wherein the configuration information is received from the network node.

18. The first wireless device of any one of claims 12 to 17, wherein the assistance information indicates that the sidelink connection between the first wireless device and the second wireless device is unstable.

19. The first wireless device of any one of claims 12 to 18, wherein the assistance information includes one or more of: an identifier of at least one of the first wireless device and the second wireless device, an indication that a positioning measurement cannot be obtained, an indication of a cause for not obtaining the positioning measurement, and sidelink PRS resource information.

20. The first wireless device of any one of claims 12 to 19, further configured to modify a sidelink positioning measurement configuration.

21. The first wireless device of claim 20, wherein modifying the sidelink positioning measurement configuration is in accordance with determining the condition associated with the sidelink connection.

22. The first wireless device of claim 20, wherein modifying the sidelink positioning measurement configuration is in accordance with receiving a message indicating to modify the sidelink positioning measurement configuration.

23. A method performed by a network node, the method comprising:
receiving, from a first wireless device, assistance information indicating a condition associated with a sidelink connection between the first wireless device and a second wireless device; and
transmitting, to at least one of the first wireless device and the second wireless device, a message indicating to modify a sidelink positioning measurement configuration.

24. The method of claim 23, further comprising, transmitting, to the first wireless device, configuration information associated with the sidelink connection including at least one criteria associated with triggering transmission of the assistance information.

25. The method any one of claims 23 to 24, wherein the assistance information includes one or more of: an identifier of at least one of the first wireless device and the second wireless device, an indication that a positioning measurement cannot be obtained, an indication of a cause for not obtaining the positioning measurement, and a sidelink PRS resource information.

26. The method any one of claims 23 to 25, wherein modifying the sidelink positioning measurement configuration includes selecting at least one additional wireless device for sidelink positioning measurement.

27. The method of claim 26, wherein the at least one additional wireless device is selected in accordance with one or more of: mobility of the additional wireless device, stability of a sidelink connection associated with the additional wireless device; radio channel quality associated with the additional wireless device, and radio channel congestion associated with the additional wireless device.

28. A network node comprising a radio interface and processing circuitry configured to:
receive, from a first wireless device, assistance information indicating a condition associated with a sidelink connection between the first wireless device and a second wireless device; and
transmit, to at least one of the first wireless device and the second wireless device, a message indicating to modify a sidelink positioning measurement configuration.

29. The network node of claim 28, further configured to transmit, to the first wireless device, configuration information associated with the sidelink connection including at least one criteria associated with triggering transmission of the assistance information.

30. The network node of any one of claims 28 to 29, wherein the assistance information includes one or more of: an identifier of at least one of the first wireless device and the second wireless device, an indication that a positioning measurement cannot be obtained, an indication of a cause for not obtaining the positioning measurement, and a sidelink PRS resource information.

31. The network node of any one of claims 28 to 30, wherein modifying the sidelink positioning measurement configuration includes selecting at least one additional wireless device for sidelink positioning measurement.

32. The network node of claim 31, wherein the at least one additional wireless device is selected in accordance with one or more of: mobility of the additional wireless device, stability of a sidelink connection associated with the additional wireless device; radio channel quality associated with the additional wireless device, and radio channel congestion associated with the additional wireless device.
